(19) United States
(12) Patent Application Publication
(10) Pub. No.: US 2015/0006744 A1
(43) Pub. Date: Jan. 1, 2015

(54) METHODS AND SYSTEMS FOR TRANSFERRING CALLS BETWEEN FORKED DEVICES

(71) Applicant: Avaya Inc., Basking Ridge, NJ (US)

(72) Inventors: Manish Chatterjee, Calcutta (IN); K. Ram Shankar, Coimbatore (IN); Biswajyoti Pal, Maharashtra (IN)

(21) Appl. No.: 13/930,830

(22) Filed: Jun. 28, 2013

(51) Int. Cl. H04L 29/06

(52) U.S. Cl. CPC H04L 65/1069
USPC 709/228

(57) ABSTRACT

Systems and methods for facilitating the forking of a communication session to a selected communication device are provided. More particularly, the capabilities of different communication devices available to a user at or in association with a first address or record (AOR) can be provided by the individual communication devices to a communication server. The communication server can then aggregate the responses, and provide a single options response message to a communication device or devices at a second AOR. The capabilities of the communication devices of one or both AORs can be presented to the users at one or both of the AORs. A selection of an alternate communication device can be made by a user after a communication is established by selecting a desired feature in a list of available features presented to that user.

### FIELD

Methods and systems for transferring calls between forked devices are provided.

### BACKGROUND

The ability to associate multiple communication devices with a common communication address, or address of record (AOR) can be a great convenience to users. For example, a user can direct calls to a desk phone when the user is in their office, or to a mobile phone when the user is travelling. The different capabilities of different devices can also enable different calling features to be accessed. For instance, a call might preferably be associated with a soft phone running on a computer where documents are to be shared between communicants. As another example, a call might preferably be associated with a speaker phone in order to facilitate hands free operation.

Although communication systems have allowed different devices with different features to be associated with a common address, there has been no reliable method for informing other communicants of the capabilities of devices that are or can be associated with an address. As result, communicants have been required to themselves communicate information to each other regarding the capabilities of alternate devices available to them. In addition, although a user having access to different communication devices with different capabilities can transfer or fork a communication session (e.g., a call) to different devices, the user is not presented with an identification of the capabilities of those devices. Accordingly, a user must already know the capabilities of devices at their disposal.

Other systems have used presence information to select from a plurality of potential communication devices. For example, presence information might be used to determine that a user is on travel. That presence information can then be applied to route a call placed to that user's desk phone to their mobile phone. However, obtaining and administering presence information adds to the complexity and expense of the system.

### SUMMARY

Systems and methods for facilitating the selection of a communication device from multiple available communication devices associated with a communication address, or address of record (AOR) are provided. After a communication session has been established, a communication server can query a set of communication devices for information regarding the capabilities of those communication devices. Moreover, a communication server can aggregate the responses from a plurality of communication devices associated with a first AOR into a single response message. The single response message can then be sent to another communication endpoint (e.g., a communication device or set of communication devices associated with a second AOR) or endpoints participating in a communication session directly, or through another communication server. Upon receiving the options message, the communication device or devices of another party or parties to the communication session can be presented with information regarding the capabilities of the available devices at the first AOR. Users at the different endpoints can be presented with both the capabilities of devices available to a communicant or communicants at the other AORs, and with the capabilities of the devices associated with their own AOR. Users at different AORs can then coordinate with one another to select another of their devices, for example to access alternate features or capabilities, and can select the other communication device based on those features or capabilities, rather than by explicitly identifying the alternate device by name or by device address.

In accordance with embodiments of the present disclosure, the information regarding the capabilities of communication devices associated with an AOR are collected at a communication or proxy server. In particular, the communication server can query the communication devices associated with a first AOR for their capabilities by sending an option request. The responses from the different communication devices associated with the first AOR are then collected at the proxy server. In accordance with embodiments of the present disclosure, the proxy server aggregates all of the responses received from the first AOR within a predetermined period of time. After that period of time has elapsed, the proxy server sends a single message to a second AOR (e.g., the other communication endpoint) with the aggregated options information. For instance, the aggregated options message can include an entry comprising the capabilities of each device associated with the first AOR. The information contained in the aggregated message can then be displayed to a user at the second AOR.

In accordance with still other embodiments, the communication devices at an AOR can register with a proxy server. The registration process can include each communication device providing a list of capabilities. This enables any one of the communication devices to display or otherwise present the capabilities of other communication devices that can operate in association with the AOR to the user. The user can then choose a communication devices from the set based on the different capabilities of the different devices.

Additional features and advantages of embodiments of the present disclosure will become more readily apparent from the following description, particularly when taken together with the accompanying drawings.

### BRIEF DESCRIPTION OF THE DRAWINGS

FIG. 1 illustrates components of a communication system in accordance with embodiments of the present disclosure;

FIG. 2 depicts components of a communication server in accordance with embodiments of the present disclosure;

FIG. 3 depicts components of a communication device in accordance with embodiments of the present disclosure; and

FIG. 4 is a flowchart depicting aspects of a method in accordance with embodiments of the present disclosure.

### DETAILED DESCRIPTION

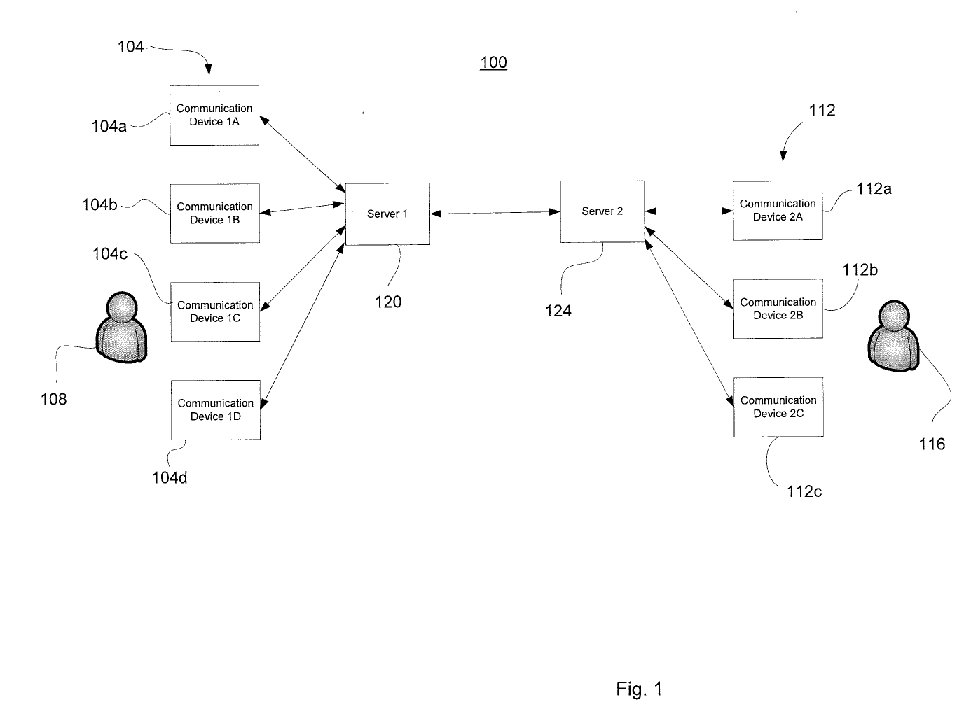

FIG. 1 depicts a communication system 100 in accordance with embodiments of the present disclosure. In general, the system 100 can include a first set of communication devices 104 associated with a first address of record (AOR). The first set of communication devices 104 can be associated with a first communicant or user 108. In addition, the system 100 can include a second set of communication devices 112 associated with a second AOR. The second set of communication devices 112 can be associated with a second communicant or user 116. One or more communication servers 120, 124 can also be included in the system 100.

In accordance with embodiments of the present disclosure, the servers 120 and 124 can be interconnected to one another by a communication network 128. The communication network 128 can include one or more networks of the same or different types. For example, the communication network 128 can include the Internet, a private intranet, the public switched telephone network (PSTN), or the like. Moreover, communication devices included in a set of communication devices 104 and 112 can be interconnected to a respective server 120 or 124 directly, or by a communication network 132 or 136, which can include one or more networks of the same or different types, such as an enterprise network, local area network (LAN), the PSTN, a direct connection, or the like. In addition, the communication system 100 can operate to support communications between a first user 108 and a second user 116. Moreover, the communications can include, but are not limited to, one or more of voice communications, video communications, textual communications, and shared files or documents. Each set 104 and 112 can include any number of communication devices. For example, but without limitation, the first set 104 can include a desk phone 104a, a soft phone and collaboration software executed by a general purpose computer 104b, a mobile phone 104c, and a video phone 104d. As a further example, again without limitation, the second set 112 can include a desk phone 112a, a soft phone and collaboration software executed by a general purpose computer 112b, and a mobile phone 112c. In addition, individual communication devices within a set 104 and/or 112 can have shared or individual device addresses that operate under or can be accessed in connection with the AOR for the set 1104 or 112.

A user 108 or 116 can select a respective communication device 104 or 112 for use in connection with a particular communication and based on various parameters. For example, if a user 108 or 116 is in their office, they may prefer to use a communication device 104 or 112 that is a desk phone. Alternatively, if the users 108 and 116 are working collaboratively on a document, they may select a respective communication device 104 or 112 that comprises a computer with a soft phone application capable of supporting voice communications and a collaboration application capable of supporting document sharing. As yet another example, a user 108 or 116 that is leaving for another location may choose a communication device 104 or 112 that comprises a mobile device. As can be appreciated by one of skill in the art after consideration of the present disclosure, a communication device within a set of communication devices 104 or 112 can be selectively forked to an in-progress communication in place of another communication device 104 or 112, for example to access different communication capabilities. In addition, as described herein, the capabilities of devices available to a user 104 by that user's own communication devices 104, and to the other user 116 by that other user's communication devices 112, can be communicated to the user 104, to assist in coordinating an optimum pair of communication devices 104 and 112 for use during a communication session.

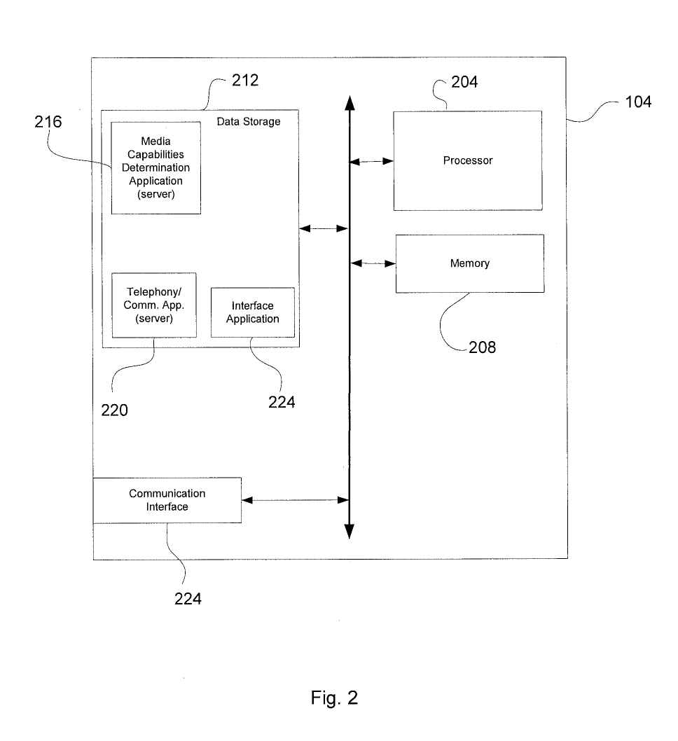

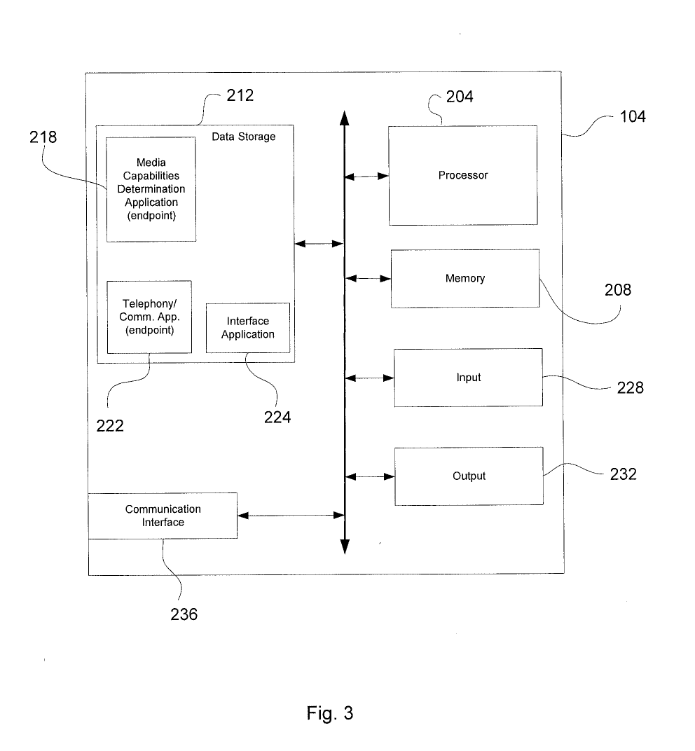

With reference now to FIGS. 2 and 3, components of communication servers 120 and 124, and a communication devices 104 and 112, are depicted. As various components can generally be common to communication servers 120 and 124 and communication devices 104 and 112, the following discussion will relates to both servers 120 and 124 and communication devices 104 and 112, unless stated otherwise. In general, the servers 120 and 124 and communication devices 104 and 112 include a processor 204. The processor 204 may comprise a general purpose programmable processor or controller for executing application programming or instructions. As a further example, the processor 204 may comprise a specially configured application specific integrated circuit (ASIC) or other integrated circuit, a digital signal processor, a programmable logic device, or the like. The processor 204 generally functions to run programming code or instructions, for example in the form of applications, implementing various functions of the communication server 104. Although shown as a single processor 204, the processor 204 may comprise multiple devices.

In addition, memory 208 is provided for use in connection with the execution of application programming or instructions by the processor 204, and for the temporary or long term storage of program instructions and/or data. As an example, the memory 208 may comprise RAM, SDRAM, or other solid state memory. Alternatively or in addition, data storage 212 can be provided as part of a server 104, 106. In accordance with embodiments of the present invention, data storage 212 can contain programming code or instructions implementing various of the applications or functions executed by the associated communication server 120 or 124, or communication device 104 or 112. Like the memory 208, the data storage 212 may comprise a solid state memory device or devices. Alternatively or in addition, the data storage 212 may comprise a hard disk drive or other random access memory.

In accordance with embodiments of the present invention, the data storage 212 can include various applications and data. For example, as illustrated in FIG. 2, a communication server 120 or 124 can include a media capabilities determination application 216, a telephony and communications application 220, and an interface application 224. As another example, and as illustrated in FIG. 3, a communication device 104 or 112 can include a media capabilities determination application 218, a telephony and communications application 222, and an interface application 224.

As can be appreciated by one of skill in the art after consideration of the present disclosure, the media capabilities determination application 216 included in a server 120 or 124 is generally operable to perform server functions, while the media capabilities determination application 218 included in a communication device 104 or 112 is generally operable to perform communication device functions. For example, the media capabilities determination application 216 on a communication server 120 or 124 can operate to collect capability information regarding a set of communication devices 104 or 112, aggregate that information into a single message, and send that single message to another set of communication devices 104 and 112. In contrast, the media capabilities determination application 218 on a communication device 104 or 112 can operate to display information regarding the capabilities of individual communication devices 104 and/or 112 within one or both sets 104 and/or 112 of communication devices to an associated user 108 or 116.

Similarly, the telephony and communication application 220 is operable to perform server functions, while the telephony and communications application 224 is operable to perform communication device functions as described herein. For example, on a communication server 120 or 124 the telephony and communications application 220 can perform session initiation protocol (SIP) communication server functions, while the telephony and communications application 222 on a communication device 104 or 112 performs SIP communication endpoint functions. The telephony/communication applications 220 and 224 can provide support for voice and/or video telephony communications between one or more communication devices 104 and 112 via one or more communication servers 120 or 124. Such communications may be established using communication channels established over a network 128 between the AOR associated with the first set of communication devices 104 and the AOR associated with the second set of communication devices 112. As can be appreciated by one of skill in the art after consideration of the present disclosure, various mechanisms and/or protocols can be used to support voice or video communication sessions, including but not limited to the Public Switched Telephone Network (PSTN), Voice over Internet Protocol (VoIP), and Session Initiation Protocol (SIP).

As yet another example, the data storage 212 can include an interface application 224. The interface application 224 can provide a connection to another device 104, 112, 120 and/or 124, directly or via a network 128.

In addition, a communication interface 224 can connect an associated device 104, 112, 120 or 124 to a user 108 or 116, or an administrator for providing input as part of a communication session and/or to receive or provide control related information for signals. As examples, a communication interface 224 can included but is not limited to a network interface card, an Ethernet interface, a public switched telephony (PSTN) interface, and a cellular telephony network interface.

One or more user input 228 and user output devices 232 can also be included. Examples of user input devices 228 include a key pad, key board, microphone, touch screen, and the like. Examples of user output devices 232 include visual display screens, speakers, printers, and the like.

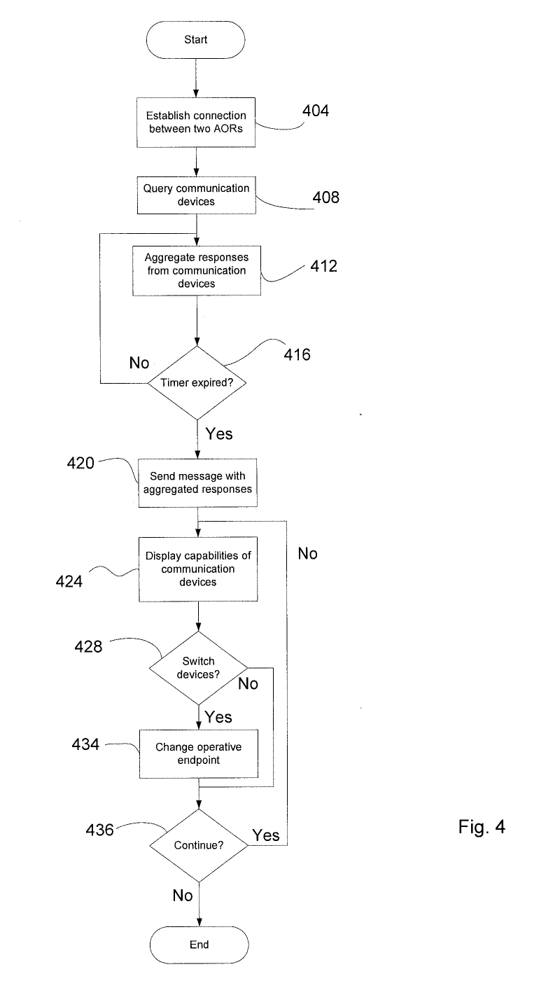

FIG. 4 is a flowchart illustrating aspects of the operation of a system 100 in accordance with embodiments of the disclosed invention. Initially, at step 404, a connection (e.g., a call) is established between AORs. For example, a first communication device 104a associated with a first AOR places a voice call to a communication device 112 associated with a second AOR. The user 116 associated with the second set of communication devices 112 might use any one of the communication devices 112 in the set to answer the call. For example, the user 108 might answer the call at a communication device 112c comprising a mobile phone. When the communication is established, the users 108 stand 116 are not provided with information regarding the capabilities of the communication devices 104 and 112 participating in the communication. Moreover, the users 108 and 116 are not aware of the different communication device 104 and 112 capabilities available at the different AORs.

At step 408, the communication devices 104 and/or 112 included in the respective set or sets are queried for their capabilities. The query can be done using the SIP options mechanism, and can be formed by the communication server 120 or 124 associated with the respective set of communication devices 104 or 112. Alternatively, one of the communication servers 120 and 124 can initiate queries to either or both of the communication device sets 104 and 112. As responses from communication devices 104 and/or 112 are received at the communication servers 120 or 124, those responses are aggregated. At step 416, the communication server or servers 120 or 124 aggregating the responses can determine whether a timer, initiated when the query was initially sent, or when a first response is received, has expired. If the timer has not expired, the process returns to step 412, to await additional responses. Once the timer expires, the process continues to step 420, and a single response message with the aggregated responses is sent. More particularly, responses received from communication devices 104 or 112 associated with a first one of the AORs are sent to the communication devices 104 or 112 associated with a second one of the AORs in a single aggregated response message. As can be appreciated by one of skill in the art after consideration of the present disclosure, this process differs from a conventional options message regarding a particular communication device 104 or 112 in that information regarding the capabilities of multiple communication devices 104 or 112 are included in a single response to a single options message. In contrast, in a conventional system, a communication server would send the response to the options message as soon as the first response to the option query is received. In contrast, embodiments of the present disclosure accumulate responses from communication devices 104 and/or 112 for a time period beginning when the query is sent, and ending when the timer expires. In accordance with other embodiments of the present disclosure, a communication server 120 or 124 can accumulate responses to the query until all communication devices within a set of communication devices 104 or 112 have provided a response.

The capabilities of the communication devices within a set of communication devices 104 or 112 are presented to the user of the other set of communication devices 104 or 112 (step 424). More particularly, the information contained in the single response message sent from the communication server 120 or 124 contains information regarding the capabilities of each communication device within the set of communication devices 104 or 112. For instance, in a particular embodiment, a line of capability information can be included for each communication device 104 or 112 responding to the query. The capabilities can be presented to the other user 108 or 116 as a visual display, for example by an output device 232. The content of the display can be generated by the media capabilities determination application 218 using an active communication device 104 or 112. In addition to displaying the capabilities of communication devices 104 or 112 available to the other user 108 or 116, the capabilities of the communication devices 104 or 112 available to the user 108 or 116 can be presented. Accordingly, a user 108 and 116 is not required to know the capabilities of the communication devices 104 or 112 that are available to them a priori. Instead, information identifying available capabilities of that user and of the other user can be presented and can be selected by the user 108 or 116 to effect a selection of an alternate communication device 104 or 112. Accordingly, the use of enhanced communication features is facilitated, because the enhanced features available to both users 108 and 116 through the communication devices 104 or 112 that can be forked to a communication session are clearly indicated to the users 108 and 116 participating in a communication session.

At step 428, a determination can be made as to whether input directing that a communication device within a set of communication devices 104 or 112 be switched has been received. For example, if input directing a change in the devices is received, the operative communication device or endpoint 104 or 112 is changed (step 434). After changing the operative communication endpoint 104 or 112, or after determining that input requesting a change in devices have not been received, a determination can be made as to whether to continue execution of the process (step 436). If operation of the process is to continue, it can return to step 424, in which the capabilities of available communication devices 104 or 112 can continue to be presented to one or both users 108 and 116. Alternatively, the process may end.

As previously noted, information regarding the capabilities of a user's 108 or 116 available communication devices can be displayed to that user 108 or 116. The information regarding those capabilities can be obtained through a registration process prior to establishing a call or other communication. For example, a first set of communication devices 104 can register with a first communication server 120, and/or a second set of communication devices 108 can register with a second communication server 124. The registration process can include providing the perspective communication server 120 or 124 with the capability information. More particularly, the communication server 120 or 124 can query the communication devices within a set 104 or 112 for capability information, and can aggregate the received responses for the respective AOR. In addition, communication devices 104 or 112 can provide their individual Globally Routable User Agent URI (GRUU). The set of forked communication devices 104 or 112 can then create a subscription to receive notifications for the registration event package corresponding to other forked devices for the same user 108 or 116 and/or AOR. The capability information is available to be presented during a communication session. Moreover, that information can be presented as a capabilities indication where an active or forked communication device 104 or 112 indicates that the communication session can be transferred to forked devices with other capabilities. For example, an options menu or list can allow the user 108 or 116 to select “transfer to video” where one of the user's 108 or 116 forked communication devices 104 or 112 supports video telephony. Accordingly, information regarding a user's 108 or 116 own communication devices can be obtained by a communication server 120 or 124 prior to the initiation of a communication session, while information regarding the communication devices of another user 108 or 116 can be obtained by the communication server 120 or 124 after a communication session is established. Alternatively, information regarding the features of available communication devices 104 and/or 112 can be obtained through the query and aggregated response process used to provide information to other users 108 or 116.

In an example scenario, a first user 108, operating a first communication device 104a associated with a first AOR can initiate a voice telephony call to a communication device 112 associated with a second AOR. As a result of a registration process completed earlier, the first communication device 104a can present a list of communication capabilities that are available through one or more communication devices included in the first set of communication devices 104. For instance, while the first communication device 104a may provide support for voice telephony, and limited text, the list of communication capabilities can also indicate video telephony, document collaboration, and mobile capabilities that are made available through one or more other communication devices 104 in the set.

The initiation of the communication session can result in ringing at one or more communication devices included in the second set of communication devices 112. The user 116 on the receiving end of the communication session can select a communication device 112 within the set of available communication devices based on the features associated with the incoming communication session, and/or based on the proximity of a selected communication device 112 to the user 116. For example, the user may choose to answer the call using a communication device 112a comprising a desk phone, because the call is limited to voice telephony, and because the desk phone 112a is in close proximity to the user 116.

After the user 116 answers, and the communication session is established, a communication server, for example the second communication server 124 proximate to the second set of communication devices 112, can query the communication devices 112 in that set for capability information using SIP options. As a particular example, but without limitation, the communication server 124 then receives SIP 200 OK responses from each of the communication devices 108 or 112, with information regarding the capabilities of the responding communication device 108 or 112. The individual option response messages sent back to the communication server 124 by the communication devices 112 are then aggregated by the communication server 124 into a single options response message. That single options response message is then provided to the first communication server 120, and then to the communication device 104 in the first set. The single options response message can include the device address for individual communication devices 112 in the second set, where some or all of the individual devices, apart from sharing the same communication address as a second AOR for the user, each have a device specific communication address in the form of a GRUU for each communication device within the set that can be provided in an options response, and do not use a shared communication address in the form of the second AOR. For example, the individual uniform resource identifier (URI) for each of the communication devices 112 within the set can be provided.

As previously noted, communication capabilities available to a user 108 and/or 116 can be presented to that user. Accordingly, if during a voice communication, the users 108 and 116 decided that it would be useful to view a document simultaneously, they can each effectively select a different communication device (e.g. a second communication device 1B 104b and a third communication device 2C 112c) by selecting a document collaboration feature from a list of features presented to the respective user 108 and 116. That is, even if the communication device 104b and 112c is in each case a soft phone and a web collaboration program running on a computer, the respective users 108 and 116 simply needs to select the document collaboration feature, rather than a soft phone and a web collaboration program on their computer. Moreover, upon selection of a new communication device 104 or 112, the selected device can ring.

Although various embodiments have been described in connection with communication sessions between two communication devices at two AORs, embodiments of the present disclosure are not limited to such arrangements. For example, embodiments of the present disclosure can be applied in connection with more than two endpoints, such as in bridged conference environments. As a further example, embodiments of the present disclosure can be applied in connection with multiple devices at a single AOR, such as when a single communication session includes a voice channel supported at an endpoint by conventional telephone and a document collaboration session supported by a web collaboration application.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A method for providing information regarding the capabilities of a plurality of communication endpoints, comprising:
associating a plurality of communication devices with a first communication address;
sending a query using SIP (session initiation protocol) from a communication server that is forked to each of the communication devices associated with the first communication address;
receiving at the communication server a response from each of the communication devices associated with the first communication address, wherein a plurality of responses are received at the communication server, and wherein each response includes information identifying the sending communication device and at least one capability of that communication device;
aggregating the plurality of responses received from the communication devices into a single response message;
sending the single response message from the communication server to a second communication address.

2. The method of claim 1, further comprising:
initiating a timer, wherein each response to the query received prior to expiration of the timer is included in the single response message.

3. The method of claim 1, wherein the second communication address is associated with at least one communication device, and wherein in response to receiving the single response message information obtained from the single response message regarding the capabilities of the set of communication devices is used to present to a user of the at least one communication device associated with the second communication address information regarding the capabilities of the plurality of communication devices associated with the first communication address.

4. The method of claim 3, wherein the information obtained from the single response message is displayed to the user of the at least one communication device associated with the second communication address.

5. The method of claim 1, wherein the single response message is a SIP (session initiation protocol) message.

6. The method of claim 5, wherein the single response message includes a device address for each of the plurality of communication devices associated with the first communication address.

7. The method of claim 5, wherein the single response message does not include all of the information included in the responses from the plurality of communication devices associated with the first address of record.

8. The method of claim 5, wherein the single response message includes one device address for each of the plurality of communication endpoints associated with the first address of record.

9. The method of claim 5, wherein the single response message includes a plurality of different device addresses, wherein at least two of the plurality of communication devices associated with the first address of record have different device addresses, and wherein at least some of the plurality of different device addresses are associated with different media and capability types.

10. The method of claim 1, further comprising:
registering each of the communication endpoints associated with the first address of record with one of the communication server and a registrar server, wherein registering includes providing information regarding the capabilities of the communication endpoints associated with the first address of record.

11. The method of claim 10, further comprising:
providing from the one of the communication server and the registrar server information regarding the capabilities of a first one of the communication endpoints associated with the first address of record to a second one of the communication endpoints associated with the first address of record;
presenting to a user of the second communication endpoint the information regarding the capabilities of the first communication endpoint.

12. The method of claim 11, further comprising:
receiving from the user a selection of a capability associated with the first communication endpoint.

13. The method of claim 12, further comprising:
in response to the user selection of a capability associated with the first communication endpoint, forking a communication from the second communication endpoint to the first communication endpoint.

14. A communication system, comprising:
a first plurality of communication devices, wherein each communication device in the first plurality of communication devices is associated with a first communication address;
a communication server, including:
a processor;
data storage;
application programming, including programming operable to query the first plurality of communication devices associated with a first communication address for communication capability information, to aggregate information included in responses from the plurality of communication devices, and to generate a message containing the aggregated information.

15. The system of claim 14, wherein the first plurality of communication devices includes at least first and second communication devices, wherein the first communication device has a different set of capabilities than the second one of the communication devices.

16. The system of claim 14, wherein the application programming implements a timer, and wherein responses from the first plurality of communication devices are aggregated until the timer expires.

17. The system of claim 14, wherein the application programming aggregates responses from all of the communication devices included in the first plurality of communication devices.

18. The system of claim 14, wherein the message containing the aggregated information includes an entry for each communication device included in the first plurality of communication devices, and wherein each entry indicates at least one capability of the associated communication device.

19. The system of claim 18, further comprising:
a second plurality of communication devices, wherein the message containing the aggregated information is received by at least a first communication device included in the second plurality of communication devices, and wherein information regarding at least first and second communication devices included in the first plurality of communication devices is presented to a user of the at least a first communication device included in the second plurality of communication devices.

20. A tangible computer readable medium having stored thereon computer executable instructions, the computer executable instructions causing a processor to execute a method for providing information regarding capabilities of a plurality of devices associated with a single communication address, the computer readable instructions comprising:
instructions to query a first plurality of communication devices associated with a first communication address;
instructions to aggregate a plurality of responses received from communication devices included in the first plurality of communication devices into a single response message;
instructions to communicate the single response message to at least a first communication device associated with a second communication address, wherein at least some of the aggregated information from the single response message is presented to a user of the first communication device associated with the second communication device.
